(19) United States
(12) Patent Application Publication
(10) Pub. No.: US 2008/0212258 A1
(43) Pub. Date: Sep. 4, 2008

(54) Electronic device and manufacturing method thereof

(75) Inventors: Takashi Fukui, Narita-shi (JP); Kazutaka Suzuki, Narita-shi (JP); Yukie Nakano, Inba-mura (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/010,814

(22) Filed: Jan. 30, 2008

(30) Foreign Application Priority Data
Feb. 5, 2007 (JP) 2007-025970
Dec. 18, 2007 (JP) 2007-326152

(51) Int. Cl. H01G 4/008

(52) U.S. Cl. 361/305; 29/25.42

(57) ABSTRACT

The electronic device according to the present invention comprises capacitor element body 4 wherein internal electrode layer 12 and ceramic layer 10 is included. Internal electrode layer 12 includes Ni and at least one element from Re, Ru, and Ir. The ceramic layer 10 substantially doesn't include Re, Ru, Os, and Ir.

### BACKGROUND OF INVENTION

1. Field of Invention

The present invention relates to an electronic device, for example such as multilayer ceramic capacitor, and manufacturing method thereof.

2. Description of Related Art

Multilayer ceramic capacitor as one example of the electronic device consists of element body comprising multilayer structure formed by alternately stacking a ceramic layer (dielectric layer) and an internal electrode layer, and a pair of external electrode formed on the both terminals of said element body.

For manufacturing this multilayer ceramic capacitor, first, the pre-fired dielectric layer and the pre-fired internal electrode layer are alternately stacked as many as required to form multilayer body. Next, this multilayer body is cut into a predetermined size to form green chip. Next, the green chip is subject to binder removal process, firing process and annealing process to form capacitor element body. The multilayer ceramic capacitor is obtained by forming a pair of external terminal electrode at the both terminals of this element body.

As mentioned above, for the manufacturing of the multilayer ceramic capacitor, the pre-fired dielectric layer and pre-fired internal electrode layer are fired simultaneously as a green chip. Hence, a conductive material comprised in the pre-fired internal electrode layer is required to have higher melting point than sintering temperature of dielectric powder in the pre-fired dielectric layer, or not to react with the dielectric powder.

As for the conductive material having high melting point, precious metal such as Pt or Pd may be used. However, since precious metals are expensive, the problem was that the multilayer ceramic capacitor using precious metal also became expensive. Hence, conventionally, as for the conductive material, base metal such as Ni was frequently used.

However, in case of using Ni as a conductive material, the problem was that the melting point of Ni (sintering temperature of internal electrode layer) was lower than sintering temperature of dielectric powder. When the pre-fired dielectric layer and pre-fired internal electrode layer were fired simultaneously at high temperature (temperature close the sintering temperature of dielectric powder), the internal electrode layer cracking or peeling were anticipated. On the other hand, when the pre-fired dielectric layer and the pre-fired internal electrode layer were fired simultaneously at low temperature (temperature close to sintering temperature of internal electrode layer) the sintering of the dielectric powder was insufficient.

Also, due to the capacitor becoming compact and having bigger capacity, if the pre-fired internal electrode layer is too thin, during sintering under reduced atmosphere, the problem was that the grain growth of Ni particles included in the conductive material takes place and becomes spherical. When the Ni particles becomes spherical, the space is produced between the Ni particles which were connected to each other before firing. That is, in the internal electrode layer after firing, arbitrary holes are formed and makes the internal electrode layer discontinuous after firing. If the internal electrode layer is not consecutive (disconnected) after firing, the capacitance of the internal electrode is reduced.

As for the solution of the above mentioned problems using Ni, as shown in patent document 1 (JP published unexamined patent application 2004-319969), a method is shown wherein a part of internal electrode later is constituted with alloy layer comprised of Ni and at least one element selected from group of Ru, Rh, Re, and Pt. In this method, internal electrode layer cracking or peeling after sintering and insufficient sintering of dielectric powder can be prevented. Also, Ni type alloy grain can be suppressed from spheroidizing. As a result, internal electrode layer can be formed continuously and the capacitance of capacitor can be suppressed.

However, in method shown in the patent document 1, the problem was that because the part of internal electrode layer is formed by Ni type alloy, reduction of insulation resistance (IR) was anticipated.

### SUMMARY OF THE INVENTION

The aim of the present invention is to provide with an electronic device such as multilayer ceramic capacitor and the manufacturing method thereof which are capable of preventing the IR deterioration, cracking and peeling of the internal electrode layer and the reduction of capacitance.

As a result of keen examination by the inventor, the IR reduction in the capacitor was found to be caused by the oxidation of metal atoms such as Re in internal electrode layer defusing to the ceramic layer (dielectric layer). Thus, the inventor invented the electronic device and the manufacturing method thereof as described hereinafter to achieve the above mentioned objectives.

The electronic device according to the present invention comprises an element body including an internal electrode layer and a ceramic layer wherein; said internal electrode layer comprises at least one element from Re, Ru, Os, and Ir; and said ceramic layer substantially doesn't comprise Re, Ru, Ou, and Ir.

Note that, according to the present invention, the ceramic layer is preferably a dielectric layer.

As for the manufacturing steps of the electronic device, when fired body is annealed, at least one element of Re, Ru, Os, and Ir included in the internal electrode layer is oxidized and diffused to the ceramic layer adjacent to the internal electrode layer. As a result, in completed electronic device, the ceramic layer may possibly include at least one element from Re, Ru, Os and Ir as well. Therefore, in the present invention, IR deterioration is obtained by substantially not including the Re, Ru, Os and Ir in the ceramic layer.

Also, due to the fact that the internal electrode layer includes not only Ni but also at least one element from Re, Ru, Os, and Ir which has higher melting point than Ni, the sintering temperature of conductive material is raised and approaches to the sintering temperature of dielectric powder. As a result, the cracking and peeling of the internal electrode layer after the sintering can be prevented, and the insufficient sintering of dielectric powder can be prevented as well. Thus, the capacitance and the IR of the capacitor are improved.

Note that, the internal electrode layer preferably includes Re from Re, Ru, Os, and Ir. Also, the total content ratio of Re, Ru, Os and Ir included in the ceramic layer is preferred to be as small as possible, and most preferably 0.

Content ratio of Ni in said internal electrode layer is, with respect to entire metal content in said internal electrode layer, preferably equal or more than 80 mol % and less than 100 mol %, and more preferably more than 87 mol % and less than 100 mol %.

Also a total content ratio of Re, Ru, Os and Ir included in said internal electrode layer is, with respect to the entire metal content included in said internal electrode layer, preferably more than 0 mol % and equal or less than 20 mol % and more preferably equal or more than 0.1 mol % and equal or less than 13 mol %.

Preferably, in said internal electrode layer, at least one element from Re, Ru, Os and Ir; and Ni forms alloy. More preferably, in said internal electrode layer, Re and Ni forms alloy.

The manufacturing method of electronic device according to the present invention comprises steps of;

forming a green chip comprising an internal electrode layer film, firing said green chip to form a fired body, and
forming said element body by annealing said fired body under an atmosphere with an oxygen partial pressure being preferably higher than 0.00061 Pa and less than 1.3 Pa, more preferably 10⁻³ to 1 Pa, and further preferably 0.0015 to 0.57 Pa, with a temperature being higher than 600° C. and lower than 1100° C., more preferably 700° C. or higher and lower than 1100° C., further preferably equal or higher than 900° C. and lower than 1100° C.

Note that, the internal electrode layer film according to the present invention indicates a part which becomes internal electrode layer in the completed electronic device.

By annealing the fired body under said atmosphere, Re, Ru, Os and Ir included in the internal electrode layer can be suppressed from diffusing into dielectric layer. As a result, in the completed electronic device, Re, Ru, Os and Ir becomes substantially possible not to be included in ceramic layer.

Also, by annealing the fired body dielectric layer under said atmosphere, dielectric layer is re-oxidized and prevented from becoming semiconductor. Thus, IR deterioration can be prevented.

Furthermore, by lowering the oxygen partial pressure under said atmosphere, oxidation of electrode near the terminal can be suppressed.

Preferably, said fired body is formed by firing said green chip under the atmosphere of oxygen partial pressure being 10⁻¹⁰ to 10⁻² Pa, and temperature being 1000 to 1300° C.

By firing the internal electrode layer (including the green chip) under the above atmosphere, while the firing starting temperature of conductive material (Ni type alloy) is rising, conductive material can prevented from the grain growth and spheroidization.

Preferably, said internal electrode layer film is formed by thin film method. As for the thin film method, preferably spattering or evaporation is used.

Preferably, said internal electrode layer film comprises crystals size of 10 to 100 nm.

Preferably, said internal electrode layer film is formed by printing method using a conductive paste comprising an alloy powder with an average particle size of 0.01 to 1 μm.

Preferably, an alloy film is formed by thin film method (preferably by spattering or evaporation) and said alloy film is pulverized to form said alloy powder.

Preferably, said alloy powder comprises crystal size of 10 to 100 nm.

### BRIEF DESCRIPTION OF THE DRAWINGS

Hereinafter, the present invention will be explained based on the embodiments shown in the drawings.

FIG. 1 is a schematic sectional view of the multilayer ceramic capacitor according to the present invention.

FIG. 2A, FIG. 2B, FIG. 2C; and FIG. 3A, FIG. 3B, and FIG. 3C are main sectional view illustrating transcription method of internal electrode layer film during the manufacturing steps of multilayer ceramic capacitor according to the present invention.

FIG. 4A is TEM-EDS spectra of the dielectric layer comprised in the multilayer ceramic capacitor according to the present invention.

FIG. 4B is a partially enlarged view of TEM-EDS spectra illustrated in FIG. 4A.

FIG. 5A is TEM-EDS spectra of the dielectric layer comprised in the multilayer ceramic capacitor according to the comparative examples of present invention.

FIG. 5B is an enlarged view of part of TEM-EDS spectra illustrated in FIG. 5A.

FIG. 6 illustrates the relation of Re content ratio in the dielectric layer (main content of dielectric layer (Ba in case of barium titanate) is set to 100 mol %) and IR of the multilayer ceramic capacitor.

### DESCRIPTION OF THE PREFERRED EMBODIMENTS

Overall Structure of Multilayer Ceramic Capacitor

First, as for the embodiment of electronic device according to the present invention, overall structure of multilayer ceramic capacitor will be explained.

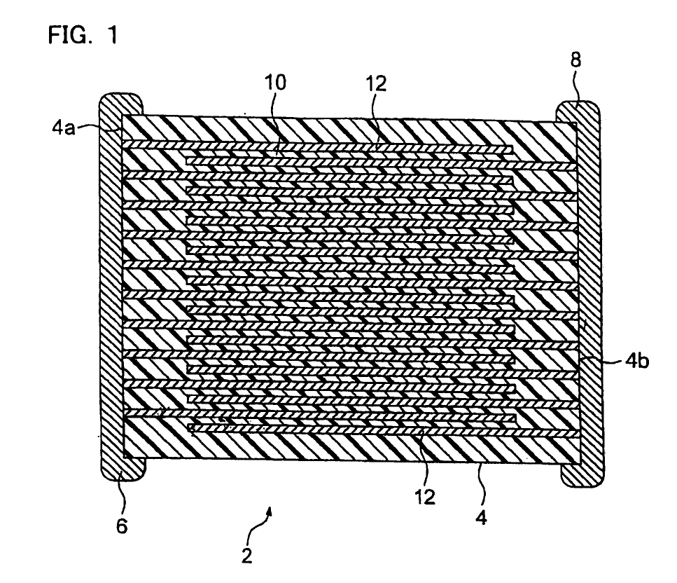

As shown in FIG. 1, multilayer ceramic capacitor 2 according to the present invention comprises element body 4 (hereafter described as capacitor element body 4), first terminal electrode 6 and second terminal electrode 8. Capacitor element body 4 comprises ceramic layer 10 (hereafter described as dielectric layer 10) and internal electrode layer 12. In between the dielectric layer 10, these internal electrode layers 12 are stacked in alternating manner. One end of the alternately stacked internal electrodes layer 12 are electronically connected to the internal of the first terminal electrode 6 formed on the external of the first terminal 4a of capacitor element body 4. The other end of the alternately stacked internal electrodes layer 12 are electronically connected to internal of the second electrode 8 formed on the external of the second terminal 4b of capacitor element body 4.

Internal electrode layer 12 includes at least one element from Re, Ru, Os, and Ir; and Ni. Preferably, internal electrode layer 12 includes Re and Ni.

Ni content ratio in the internal electrode layer 12 is equal or more than 80 mol % and less than 100 mol % with respect to the entire metal content included in said internal electrode layer 12; more preferably, it is equal or more than 87 mol % and less than 100 mol %. The total content ratio of Re, Ru, Os, and Ir included in said internal electrode layer 12 is more than 0 mol % and equal or less than 20 mol %, and more preferably equal or more than 0.1 mol % and equal or less than 13 mol %. IF the Ni content ratio is too large, the effect of the present invention tends to be less, and if too little, unfavorable condition such as increase of the dielectric loss tan δ tends to take place more frequently. Also, if the total content ratio of Re, Ru, Os and Ir is too large, problems such as the resistance ratio rise of the metal film tends to occur. Note that, with respect to the entire metal content, various trace component for example P can be included in condition of less than 0.1 mol % or so.

Preferably, in the internal electrode layer 12, Ni and at least one element from Re, Ru, Os and Ir forms alloy. As for the composition of alloy (combination of metal) it is not particularly limited; however, Ni—Re, Ni—Ru, Ni—Os, and Ni—Ir may be used. Preferably, in the internal electrode layer 12, Re and Ni forms alloy. Note that, as for the conductive material, alloy constituted from more than 3 types of said metals including Ni can be used. Also, conductive material particles constituting the internal electrode layer 12 don't necessarily have to be alloy. For example, it can be single particle from said metals or particles constituted by plurality of metal layer constituted only by said metals.

The thickness of internal electrode layer 12 is not particularly limited; however, preferably it is 0.1 to 1 μm.

As for the main component of dielectric layer 10 (ceramic layer), although not particularly limited, calcium titanate, strontium titanate and/or barium titanate may be used as example of dielectric material. Thickness of each dielectric layer is not particularly limited, however generally it is several μm to several hundreds μm. Particularly in the present invention, it is preferably set as thin as less than 5 μm, and more preferably less than 3 μm.

Dielectric layer 10 substantially don't include Re, Ru, Os, and Ir. Further specifically, the total content ratio of Re, Ru, Os, and Ir in the dielectric layer 10 is, with respect to the main content element (Ba in case of barium titanate), equal or less than 0.5 mol %. The total content ratio of Re, Ru, Os, and Ir in the dielectric layer 10 is preferred to be as small as possible and most preferably 0.

The material of terminal electrode 6 and 8 is not particularly limited; however, generally copper or copper alloy, Ni or Ni alloy are used. Alternatively, silver or alloy of silver and palladium can be used as well. Thickness of terminal electrode 6 and 8 is not particularly limited; however, usually it is 10 to 50 μm.

The shape and size of the multilayer ceramic capacitor 2 can be determined accordingly depending on the use and the aim thereof. If the multilayer ceramic capacitor is rectangular parallelepiped shape, usually the size is length (0.6 to 5.6 mm, preferably 0.6 to 3.2 μm)×width (0.3 to 5.0 mm, preferably 0.3 mm to 1.6 mm)×thickness (0.1 to 1.9 mm, preferably 0.3 to 1.6 mm) or so.

Manufacturing Method of Multilayer Ceramic Capacitor 2

Next, an example of multilayer ceramic capacitor 2 will be explained.

(Formation of Internal Electrode Layer Film)

First, the formation of internal electrode layer film will be explained. This internal electrode layer constitutes internal electrode layer 12 in the completed multilayer ceramic capacitor 2 (FIG. 1).

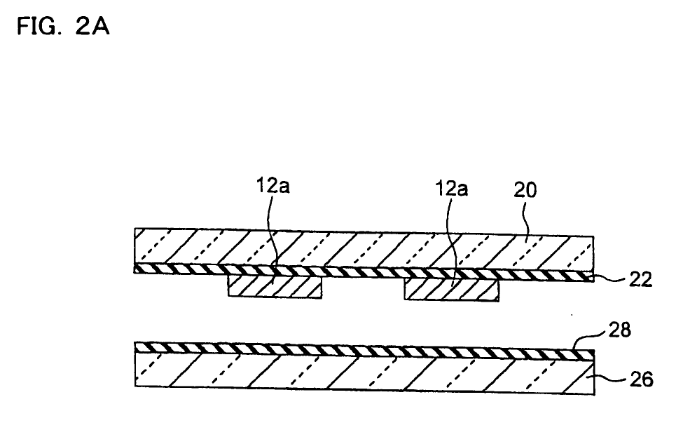

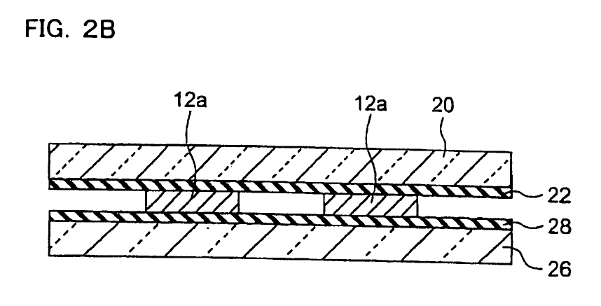

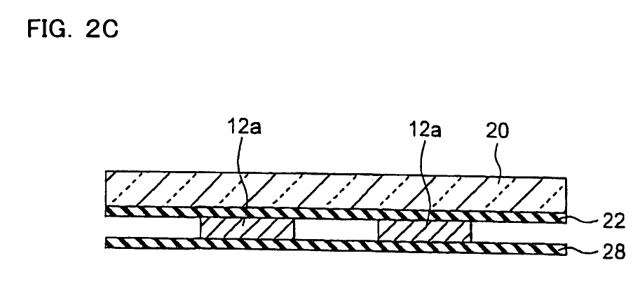

First, as shown in FIG. 2A, carrier sheet 20 as for the first support sheet is prepared, and an ablation layer 22 is formed thereon. Next, on the surface of the ablation layer 22, the internal electrode layer film 12a with predetermined pattern is formed.

The thickness of the formed internal electrode layer film 12a is preferably, 0.1 μm to 1 μm, and more preferably 0.1 μm to 0.5 μm or so. The internal electrode layer film 12a may be constituted of single layer or of plurality of layers with more than 2 different components.

As for the formation method of the internal electrode layer film 12a, although not particularly limited, preferably thin film method or printing method may be used.

(Thin Film Method)

As for the thin film method, although not particularly limited; plating, spattering, or evaporation may be used. Preferably, spattering or evaporation is used.

A target material used in the spattering includes at least one element from Re, Ru, Os, and Ir; and Ni. Preferably, as for the target material, at least one Ni alloy of above mentioned Ni—Re, Ni—Ru, Ni—Os and Ni—Ir is used. Note that, the target material doesn't necessarily have to be alloy.

As for the condition of spattering, although not particularly limited, the degree of vacuum is preferably equal or less than 10⁻² Pa, and more preferably equal or less than 10⁻³ Pa. The Ar gas introduction pressure is preferably 0.1 to 2 Pa and further preferably 0.3 to 0.8 Pa. Output is preferably 50 to 400 W, and further preferably 100 to 300 W. Spattering temperature is preferably 20 to 150° C., and further preferably 20 to 120° C.

The composition of the internal electrode layer film 12a formed by spattering is same as the composition of target material.

The materials used for the evaporation is, although not particularly limited, halide of metal (Ni and at least one element from Re, Ru, Os, and Ir) and metallic alkoxide or so may be used. These are vaporized, for example by reducing with H₂ gas, to form above mentioned internal electrode layer film 12a.

Note that, the internal electrode layer film 12a formed by the thin film method, spattering or evaporation includes metal particles with crystal size of preferably 10 to 100 nm and further preferably 30 to 80 nm. If the crystal size is too small, problems such as disconnection or spheroidization occur, and if too big, problems such as unevenness of the thickness of the film occur.

(Printing)

As for the printing, although not particularly limited, screen printing and gravure printing may be used. In case of forming the internal electrode layer 12a by printing method, it will be performed as following.

First, on the carrier sheet (not shown in the figure), a separate ablation layer (not shown in the figure) different from the ablation layer 22 illustrated in FIG. 2A is formed.

Next, on the ablation layer, by above mentioned thin film method, Ni alloy film is formed. Next, the formed Ni alloy film is removed from the carrier sheet and; pulverized and classified to obtain alloy powder with average particle size of 0.01 to 1 μm. Preferably, the alloy powder comprises crystal size of 10 to 100 nm. If the crystal size is too small, problems such as disconnection or spheroidization occur and if too big, a problem such as unevenness of the thickness of the film occurs.

Next, this alloy powder is kneaded with organic vehicle and made into a paste to obtain conductive paste for forming the internal electrode layer. The material for organic vehicle can be the same material used in the dielectric paste described hereafter. The obtained conductive paste is formed on the surface of the ablation layer 22 in a predetermined ablation layer shown in FIG. 2A by printing. As a result, the internal electrode layer film 12a is obtained.

(Formation of Green Sheet)

Next, the formation of the green sheet will be explained.

The green sheet will constitute dielectric layer 10 in the completed multilayer ceramic capacitor 2 (FIG. 1).

First, a dielectric paste which is the material of green sheet is prepared. The dielectric paste is constituted by, usually, an organic paste or water-based paste obtained by kneading the dielectric material and organic vehicle.

As for the dielectric material, respective chemical compounds which can be composite oxides or oxides, for example it is selected accordingly from carbonate, nitrate, hydroxide and organic metal compounds or so, and these are mixed to be used. The dielectric material is usually used for the powder with average particle size of 0.1 to 3.0 μm or so. Note that, for forming extremely thin green sheet, powder with particle size smaller than the thickness of the green sheet is preferred.

The organic vehicle is a binder dissolved in the organic solvent. As for the binder used in the organic vehicle, although not particularly limited, general respective binder such as ethyl cellulose, polyvinylbutyral, acrylic resin or so may be used. Preferably, butyral resin such as polyvinylbutyral is used.

Also, the organic solvent used in the organic vehicle is not particularly limited, organic solvent such as terpineol, butyl carbitol, acetone, or toluene is used. Also, vehicle in the water-based paste is an water-based binder dissolved in water. Water-based binder is not particularly limited, polyvinyl alcohol, methyl cellulose, hydroxyl ethyl cellulose, water-based acrylic resin, or emulsion is used. The amount of content of each component is not particularly limited, general amount of content, for example it can be 1 to 5 wt % or so of binder, and 10 to 50 wt % or so of solvent (or water).

In the dielectric paste, if needed, the additives selected from the respective; dispersing agents, plasticizer, dielectric body, glass frit, and insulator may be comprised. However, the total amount of content is preferably equal or less than 10 wt %. When using butyral type resin as binder resin, with respect to 100 parts by weight of binder resin, the amount of content of the plasticizer comprises preferably 25 to 100 parts by weight. If the plasticizer is too little, the green sheet tends to become fragile, and if the plasticizer is too much, the plasticizer will leak out and becomes difficult to handle.

Next, as shown in FIG. 3A, by doctor blade method or so, above mentioned dielectric paste is applied on to the carrier sheet 30 (second support sheet) to form green sheet 10a. The thickness of the green sheet 10a is preferably 0.5 to 30 μm, and more preferably 0.5 to 10 μm or so. The green sheet 10a is dried after formed. The drying temperature of green sheet 10a is preferably 50 to 100° C. and the drying time is preferably 1 to 5 minutes.

(Stacking Step)

Next, the step of stacking the internal electrode layer film 12a and the green sheet 10a formed by the above mentioned method will be explained.

As shown in FIG. 2A, first, adhesive layer 28 is formed on the surface of the carrier sheet 26 (third support sheet), and adhesive layer transferring sheet is prepared. The carrier sheet 26 is constituted from the sheet same as said carrier sheet 20 and 30.

Next, as show in FIG. 2B, the adhesive layer 28 formed on the carrier sheet 26 is pressed against the internal electrode layer film 12a and heat pressured. Then, by removing the carrier sheet 26, as shown in FIG. 2C and FIG. 3A, the adhesive layer 28 is transferred on the surface of the internal electrode layer film 12a.

The heating temperature during the transferring is preferably 40 to 100° C., and the pressure is preferably 0.1 to 15 MPa. The pressure can be applied by press or calendar roll; however, a pair of roll is preferably used.

Next, as shown in FIG. 3B, the internal electrode layer film 12a formed on the carrier sheet 20 is pressed against on the surface of the green sheet 10a via adhesive layer 28, and heat pressured. Then, by removing the carrier sheet 30, as shown in FIG. 3C, the internal electrode layer film 12a is transferred on the surface of the green sheet 10a. Note that, the method of transferring is as same as the transferring of adhesive layer 28.

By the above mentioned method, as shown in FIG. 3C, plurality of multilayer ceramic capacitor comprising a pair of green sheet 10a and internal electrode layer film 12a are made. These multilayer body units are stacked on each other to form a multilayer body wherein the internal electrode layer film 12a and the green sheet 10a are alternately stacked. Note that, when performing this stacking, the carrier sheet 20 is removed from each multilayer body unit.

Next, after stacking the external layer green sheet on the both sides of this multilayer body in the stacking direction, final heating and pressure is applied to the multilayer body. The pressure of final pressure is preferably 10 to 200 MPa. The heating temperature is preferably 40 to 100° C.

Next, the multilayer body is cut into predetermined size to form green chip.

(Binder Removal, Firing, and Annealing)

Next, binder removal is performed to the green chip.

When using base metal Ni as a conductive material to form the internal electrode layer as the present invention, binder removal is preferably performed under air atmosphere or N₂ atmosphere. Also, as the additional binder removal conditions, preferably the temperature rising rate is 5 to 300° C./hour, and more preferably 10 to 50° C./hour. The holding temperature is preferably 200 to 400° C., and more preferably 250 to 350° C. The temperature holding time is preferably 0.5 to 20 hours, and more preferably 1 to 10 hours.

Next, the green chip is fired after the binder removal process to form a fired body.

In the present invention, the green chip is fired under atmosphere of oxygen partial pressure preferably 10⁻¹⁰ to 10⁻² Pa, and more preferably 10⁻¹⁰ to 10⁻⁵ Pa. Also, the green chip is fired under temperature atmosphere preferably 1000 to 1300° C., and more preferably 1150 to 1250° C.

If the oxygen partial pressure is too low during the firing, abnormal sintering of the conductive material (alloy) of the internal electrode layer film takes place and may be disconnected. On the other hand, if the oxygen partial pressure is too high, the internal electrode layer tends to be oxidized. Furthermore, if the firing temperature is too low, the green chip will not be densified. On the other hand, if the firing temperature is too high, the internal electrode may break, the temperature capacity characteristics may deteriorate due to diffusion of the conductive material or the dielectric body may be reduced.

In the present invention, by firing the green chip under the above mentioned atmosphere, these defects can be prevented. That is, by firing under the above mentioned atmosphere, while raising the firing starting temperature of conductive material (Ni type alloy), the grain growth of the conductive material (Ni type alloy) and spheroidization can be suppressed. As a result, the internal electrode layer can be formed continuously without breakage and the capacitance reduction of the capacitor can be suppressed.

As for the further conditions of the firing, preferably the temperature rising rate is 50 to 500° C./hour, and more preferably 200 to 300° C./hour. The temperature holding time is preferably 0.5 to 8 hours, and more preferably 1 to 3 hours. The cooling rate is preferably 50 to 500° C./hour, and more preferably 200 to 300° C./hour. Furthermore, the firing atmosphere is preferred to be reduced atmosphere. As for the atmospheric gas, for example, a mixed gas of N₂ and H₂ is preferably used under wet condition.

Next, the fired body of the green chip after firing is annealed to form capacitor element body 4 (FIG. 1). The annealing is a process to re-oxidize the dielectric layer. Due to this annealing process, the capacitor IR can be improved, and the IR accelerated life time can be extended.

In the present invention, the annealing of the fired body is preferably performed under higher oxygen partial pressure than that of reduced atmosphere during the firing. Specifically, the fired body is annealed under the atmosphere of oxygen partial pressure preferably higher than 0.00061 Pa and less than 1.3 Pa, more preferably, it is 10⁻³ to 1 Pa, and further preferably 0.0015 to 0.57 Pa. Also, the holding temperature or maximum temperature during the annealing is preferably higher than 600° C. and less than 1100° C., more preferably equal or higher than 700° C. and less than 1100° C., and further preferably equal or higher than 900° C. to less than 1100° C.

In the present invention, by annealing the fired body under the above mentioned atmosphere, the ceramic of the dielectric layer can be re-oxidized sufficiently; and Re, Ru, Os, and Ir included in the internal electrode layer is oxidized which enables to suppress the diffusion to the dielectric layer. As a result, in the completed capacitor, the total content ratio of Re, Ru, Os, and Ir included in the dielectric layer can be made to equal or less than 0.5 mol % with respect to main component element (Ba in case of barium titanate) included in the dielectric layer. That is, Re, Ru, Os and Ir are substantially possible not to be included in the dielectric layer. As a result, the capacitor Ir doesn't deteriorate.

If the oxygen partial pressure is too low during the annealing, the dielectric layer re-oxidation becomes insufficient resulting in IR characteristics deterioration. Also, due to the annealing insufficiency, tan δ will also increase. On the other hand, if the oxygen partial pressure is too high, internal electrode layer film tends to oxidize. Also, if the holding temperature during the annealing is below said range, re-oxidation of the dielectric material becomes insufficient; IR becomes low, and tan δ will also increase. On the contrary, if the holding temperature during the annealing exceeds said range, Ni of the internal electrode will be oxidized resulting in the reduction of capacitance of the capacitor. Furthermore, Re, Ru, Os and Ir becomes oxidized, will be diffused into the dielectric layer, IR will deteriorate, and tan δ will also increase. In the present invention, by annealing the fired body under above mentioned atmosphere, these problems can be prevented.

As for the further annealing conditions, the temperature of holding time is preferably 0.5 to 4 hours, and more preferably 1 to 3 hours. Also, the cooling rate is preferably 50 to 500° C./hour, and more preferably 100 to 300° C./hour. Furthermore, as for the atmospheric gas of annealing is, for example, wet N₂ gas or so is preferably used. When wetting the N₂ gas, wetter or so may be used. In this case, water temperature is preferably 0 to 75° C. or so.

Note that, above mentioned binder removal process, firing, and annealing can be performed either continuously or independently.

Next, to the obtained capacitor element body 4 (FIG. 1), end face polishing is performed by for example barrel polishing, sand blast or so. Next, the terminal electrode paste is fired on each end face to form first terminal electrode 6 and second electrode layer 8. The firing of the terminal electrode paste is done, for example, in the mixed gas of wet N₂ and H₂. The mixed gas temperature is preferably 600 to 800° C., the heating time is 10 minutes to 1 hour or so. Then, if necessary, terminal electrode 6 and 8 is plated, and pad layer is formed. Note that, terminal electrode layer paste can be prepared as above mentioned electrode paste.

The multilayer ceramic capacitor 2 manufactured as said is mounted on the printed board by soldering or so and used in respective electronic devices.

In the present invention, when annealing the fired body, at least one element from Re, Ru, Os, and Ir included in the internal electrode layer (internal electrode layer film) prevents from diffusing into the dielectric layer (green sheet) adjacent to the internal electrode layer (internal electrode layer film). As a result, in the completed multilayer ceramic capacitor 2 (FIG. 1), Re, Ru, Os, and Ir are not substantially included in the dielectric layer 10. Thus, IR deterioration of multilayer ceramic capacitor 2 can be prevented. In other words, by making the total content ratio of Re, Ru, Os and Ir included in the dielectric layer 10 to less than 0.5 mol %, with respect to the main component element included in the dielectric layer 10 (Ba in case of barium titanate), the IR deterioration of multilayer ceramic capacitor 2 can be prevented.

Also, because the internal electrode layer 12 includes not only Ni and at least one element from Re, Ru, Os, and Ir which has higher melting point than Ni as conductive material, the conductive material sintering temperature increases and approaches close to the sintering temperature of the dielectric powder. As a result, the breaking and peeling of the internal electrode layer 12 after the sintering can be prevented, and the insufficient sintering of dielectric powder can be prevented as well.

In the present invention, the fired body is annealed under the annealing atmosphere of the oxygen partial pressure being preferably higher than 0.00061 Pa and less than 1.3 Pa, more preferably 10⁻³ to 1 Pa, and further preferably, 0.0015 to 0.57 Pa; the temperature is preferably higher than 600° C. and less than 1100° C., more preferably equal or higher than 700° C. and less than 1100° C., and further preferably 900° C. or higher and less than 1100° C. As a result, Re, Ru, Os and Ir included in the internal electrode layer 12 can be suppressed from diffusing into dielectric layer 10. Thus, dielectric layer 10 can substantially not include Re, Ru, Os and Ir. As a result, the IR deterioration of multilayer ceramic capacitor 2 can be prevented.

Also, by annealing the fired body under above mentioned atmosphere, the dielectric layer 10 is re-oxidized, is interfered from becoming a semiconductor and IR can be increased.

Hereinabove, the embodiments of the present invention was explained. However, the present invention is not limited to these embodiments, and the present invention can be performed in various forms within the scope of the invention.

For example, instead of forming the alloy powder (conductive material) included in the conductive paste of the internal electrode layer by pulverizing the alloy film, it can be formed directly by chemical vapor deposition (CVD) method. In this case, the same effects as the above mentioned embodiments can be obtained. By making the alloy powder by CVD method, the average particle size of the alloy powder can be controlled finely, and the sharp particle distribution of the alloy powder can be made. Note that, the average particle size or the composition of the alloy powder can be controlled by flow of the carrier gas which carries the vaporization material, reaction temperature, or the relative amount of material to be reacted.

Also, the present invention is not limited to multilayer ceramic capacitor, and can be applied to other electronic devices. As for the other electronic devices, it is not particularly limited, piezoelectric element, chip inductor, chip varistor, chip thermistor, chip resistance, and other surface mount device (SMD) chip type electronic device may be used as examples.

### EXAMPLES

Hereafter, the present invention will be explained based on the examples, however the present invention is not limited to these examples.

### Example 1

First, by CVD method, the conductive material (alloy powder) of internal electrode layer was manufactured. As for the conductive material source, Ni chloride and Re chloride was used. The Crucible introduced with Ni chloride and the crucible introduced with Re chloride was placed on the source vaporizer of CVD device; and Ni chloride and Re chloride were vaporized. This vaporized Ni chloride and Re chloride were carried by carrier gas N₂ to a reactor of CVD device. The flow of the carrier gas was set to 3 L/min. The reactor was heated to 1100° C., and due to the H₂ gas as reducing gas supplied at 5 L/min to the reactor, the reduction reaction of Ni chloride and Re chloride takes place which produced Ni—Re alloy powder. The produced Ni—Re alloy powder is cooled in the cooler along with the carrier gas. Then, it is discharged from the reactor and collected by collecting device.

The obtained conductive material (Ni—Re alloy powder) had average grain size of 300 nm, and the Re content ratio of alloy powder with respect to entire alloy was about 20 mol %.

With respect to 100 parts by weight of this conductive material, as common material grain, 20 parts by weight of average grain size of 50 nm of BaTiO₃ powder (BT-005/SAKAI CHEMICAL INDUSTRY Co., LTD.) was added, and organic vehicle (4.5 parts by weight of binder resin dissolved in 228 parts by weight of terpineol) was added and kneaded by triple roll to make slurry in order to produce a conductive paste to form the internal electrode.

Next, BaTiO₃ powder (BT-005/SAKAI CHEMICAL INDUSTRY Co., LTD.), MgCO₃, MnCO₃, (Ba_{0.6}Ca_{0.4})SiO₃ and powder selected from rare earth element (Gd₂O₃, Tb₄O₇, Dy₂O₃, Ho₂O₃, Er₂O₃, Tm₂O₃, Yb₂O₃, Lu₂O₃, Y₂O₃) were wet mixed in ball mill for 16 hours, and dried to form dielectric material. These basic ingredient powders had average particle size of 0.1 to 1 μm. BaCO₃, CaCO₃ and SiO₂ were wet mixed in ball mill and was fired in air after drying, then wet pulverized to make (Ba_{0.6}Ca_{0.4})SiO₃.

Next, in order to make the obtained dielectric material into a paste, organic vehicle was added to the dielectric material, and mixed in ball mill to obtain dielectric paste. The organic vehicle was, with respect to 100 parts by weight of dielectric material, the proportioning ratio of; poly vinyl butyral as binder: 6 parts by weight; Bis(2-ethylhexyl)phthalate) (DOP) as plasticizer: 3 parts by weight; ethyl acetate: 55 parts by weight; toluene: 10 parts by weight; and paraffin as parting agent: 0.5 parts by weight.

Next, the dielectric material was made into 2× dilution in weight ratio by ethanol/toluene (55/10) to form ablation paste.

Next, except for not including dielectric particles and parting agent, same paste as said dielectric paste was made. 4× dilution in weight ratio of this paste were made by toluene. Adhesive layer paste was made in such way.

Next, by using above dielectric paste, the green sheet 10a with thickness of 1.0 μm (FIG. 3A) was made on PET film (second support sheet) using wire bar coater.

Next, above ablation layer film was paste-dried by wire bar coater on the other PET film (first support sheet) to form ablation layer with thickness of 0.3 μm.

Next, using the above conductive paste, by screen printing method, as shown in FIG. 2A, on the surface of ablation layer 22, predetermined pattern of internal electrode layer film 12a was formed. The thickness of this internal electrode layer film 12a after drying was 0.5 μm.

Next, as shown in FIG. 2A, the above adhesive layer paste was paste-dried by wire coater bar onto PET film (third support sheet) wherein peeling process has been performed on the surface by silicon-based resin, and adhesive layer 28 with thickness of 0.2 μm was formed thereon.

Next, the adhesive layer 28 was transferred onto the surface of internal electrode layer film 12a by method shown in FIG. 2B and FIG. 2C. A pair of roll was used during transferring and the pressure thereof was 0.1 MPa and temperature was 80° C.

Next, in the method shown in FIG. 3B, internal electrode layer film 12a was adhered (transferred) onto the surface of green sheet 10a via adhesive layer 28 to form multilayer unit shown in FIG. 3C. Plurality of these multilayer body units was formed. A pair of roll was used during the transferring and the pressure thereof was 0.1 MPa and temperature was 80° C.

Next, these multilayer body units were stacked on each other, and the multilayer body comprising a structure wherein the internal electrode layer film 12a and green sheet 10a is alternately stacked was formed. The number of internal electrode layer film comprising the multilayer body was 21 layers. The stacking condition was; pressure was 50 MPa and the temperature during pressuring was 120° C. Then, the multilayer body was cut in to predetermined dimension to form green chip.

Next, the green chip was subject to the binder removal process under following atmosphere.

Temperature rising rate: 5 to 300° C./hour,
holding temperature: 200 to 400° C.,
holding time: 0.5 to 20 hours, and
atmosphere gas: wet N₂ gas.

Next, the green chip after the binder removal process was fired under the following atmosphere to obtain the fired body.

Temperature rising rate: 5 to 500° C./hour,
holding temperature: 1200° C.,
holding time 0.5 to 8 hours,
cooling speed: 50 to 500° C./hour,
atmosphere gas mixed gas of wet N₂ and H₂, and
oxygen partial pressure: 10⁻⁷ Pa.

Next, the fired body was annealed under following atmosphere to form capacitor element body.

Temperature rising rate: 200 to 300° C./hour,
holding temperature: 700° C.,
holding time: 2 hours,
cooling rate: 300° C./hour,
atmosphere gas: wet N2 gas, and
oxygen partial pressure: 2.0×10⁻³ Pa.
Note that, for wetting the atmosphere gas, wetter was used and the water temperature was 0 to 75° C.

Next, the edge of capacitor element body was polished by sandblast. Then, the external electrode paste was transferred on to each edge. Next, the capacitor element body was fired in wet N₂+H₂ atmosphere for 10 minutes under 800° C., and external electrode was formed. The sample of multilayer ceramic capacitor with the structure shown in FIG. 1 was obtained in such way.

The size of obtained sample was 3.2 mm×1.6 mm×0.6 mm wherein the number of dielectric layer sandwiched between the internal electrode layers were 21 with thickness of 1 μm, and the thickness of internal electrode layer 12 was 0.5 μm. Thickness of each layer (film thickness) was measured by SEM observation.

### Example 2 to 13, Comparative Example 1 to 4

In example 2 to 13 and comparative example 1 to 4, during the annealing of fired body, holding temperature and the oxygen partial pressure of the annealing atmosphere was set to the value shown in Table 1. Except for that, the multilayer ceramic capacitor of example 2 to 13 and comparative example 1 to 4 was made in same condition as example 1.

TABLE 1
Re content ratio included in internal electrode layer: 2O mol %

| | Annealing atmosphere | | | | | | |
|---|---|---|---|---|---|---|---|
| | | Oxygen | Recontent ratio | | | Resistance | |
| | Holding | partial | included in dielectric | | | ratio of | |
| | temp. | pressure | layer | IR | Capacitance | electrode film | |
| | (°C) | (Pa) | (mol %) | (Ω) | (μF) | (×10⁻⁸ Ωm) | tan δ |
| Example 1 | 700 | 0.0020 | below the detection limit | 1.0E+09 | 1.7 | 29 | 0.19 |
| Example 2 | 700 | 0.020 | below the detection limit | 7.2E+08 | 1.6 | 29 | 0.15 |
| Example 3 | 800 | 0.013 | below the detection limit | 7.4E+08 | 1.6 | 29 | 0.09 |
| Example 4 | 900 | 0.0015 | below the detection limit | 1.2E+09 | 1.7 | 29 | 0.05 |
| Example 5 | 900 | 0.062 | below the detection limit | 8.0E+08 | 1.7 | 29 | 0.04 |
| Example 6 | 1000 | 0.076 | below the detection limit | 1.5E+09 | 1.6 | 29 | 0.01 |
| Example 7 | 1000 | 0.003 | below the detection limit | 2.0E+09 | 1.7 | 29 | 0.01 |
| Example 8 | 1030 | 0.11 | below the detection limit | 1.5E+09 | 1.6 | 29 | 0.01 |
| Example 9 | 1030 | 0.003 | below the detection limit | 2.0E+09 | 1.7 | 29 | 0.01 |
| Example 10 | 1050 | 0.1 | below the detection limit | 9.0E+08 | 1.6 | 29 | 0.02 |
| Example 11 | 1080 | 0.19 | below the detection limit | 8.0E+08 | 1.4 | 29 | 0.03 |
| Example 12 | 1080 | 0.003 | below the detection limit | 1.5E+09 | 1.4 | 29 | 0.02 |
| Example 13 | 1080 | 0.57 | below the detection limit | 8.0E+08 | 1.4 | 29 | 0.05 |
| Comparative example 1 | 1090 | 0.00061 | 0.7 | 3.5E+08 | 1.6 | 29 | 0.03 |
| Comparative example 2 | 1080 | 1.3 | 1.0 | 4.3E+06 | 1.4 | 29 | 0.09 |
| Comparative example 3 | 1100 | 0.23 | 0.9 | 1.3E+08 | 1.6 | 29 | 0.15 |
| Comparative example 4 | 1200 | 0.62 | 1.3 | 870 | 0.8 | 29 | 0.35 |

Evaluation 1

The measurement of Re Content Ratio

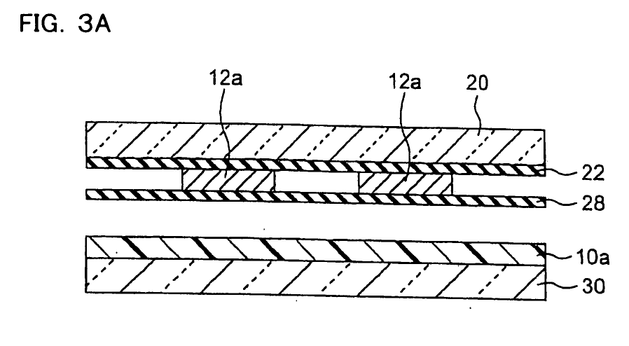

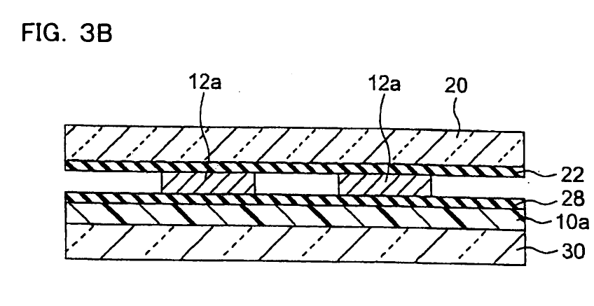

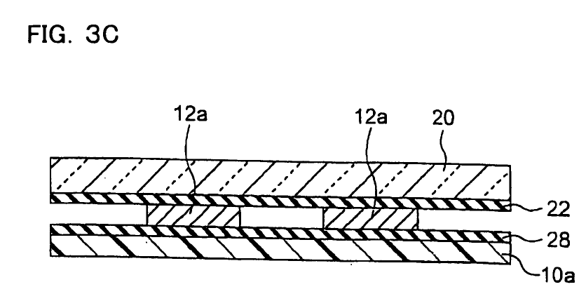

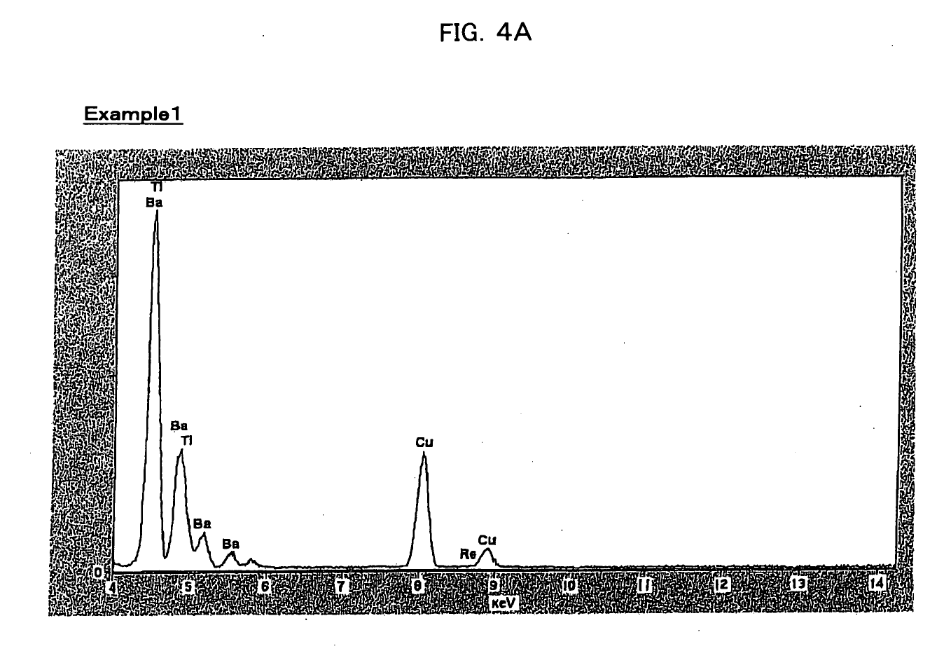

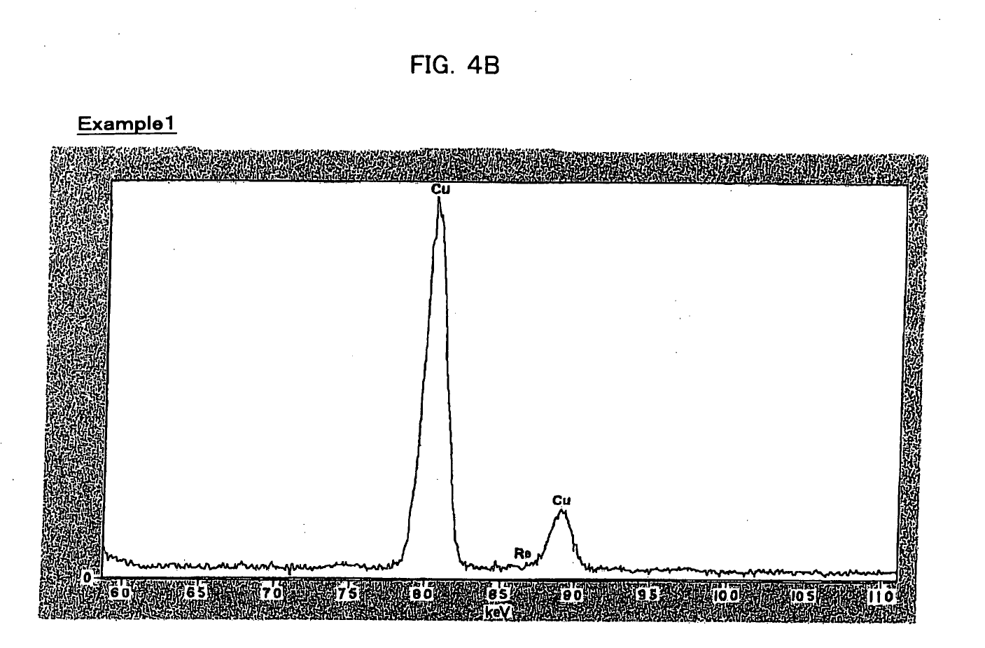

In the multilayer ceramic capacitor obtained from example 1 to 13 and comparative example 1 to 4, the composition of dielectric layer (ceramic layer) constituting dielectric body was analyzed. Further specifically, first, multilayer ceramic capacitor as a sample was polished perpendicular to the stacking direction to expose the dielectric layer. Next, by Transmission Electron Microscope Energy Dispersive X-ray Spectrometry (TEM-EDS) method using transmission electron microscopy, the 30 arbitrary points of dielectric ceramic layer sandwiched between the internal electrode was subject to the composition analysis, and the average thereof was considered as Re content. Specifically, the Re content ratio included in the dielectric ceramic layer (Re amount (mol %) with respect to Ba which is a main component of dielectric ceramic layer) was determined. Note that, 1 nm probe was used for the electron beam for the analysis. Results are shown in FIG. 4A, 4B, 5A, 5B, and Table 1.

Measurement of Electronic Characteristic Value

For the multilayer ceramic capacitor obtained from example 1 to 13 and comparative example 1 to 4, the electronic characteristics were measured. Specifically, insulation resistance IR (unit: Ω) was measured. For the measurement of IR, temperature adjustable IR meter was used. The measurement was performed under the condition of; room temperature, measuring voltage 6.3 V, and voltage application time 60 s. The larger the IR, the more preferable it is. Specifically, IR is preferably larger than 7.0×10⁸Ω, and more preferably 8.0×10⁸Ω. The results are shown in Table 1.

Also, with respect with the capacitor sample, under the condition of reference temperature of 25° C. with digital LCR meter (YHP4274A), frequency of 1 kHz, input signal level (measuring voltage) 1 Vrms, the capacitance and dielectric loss (tan δ) were measured. The results are shown in Table 1. Furthermore, the resistivity of metal film with same composition as the internal electrode layer was measured. The resistivity (unit is Ω·m) was measured using resistivity meter (made by NPS, Σ-5) to the sputtered film (before firing) on the glass substrate with DC four probe method (current 1 mA, 2 seconds) at 25° C. Preferably, the resistivity was considered GOOD when it was below 70×10⁻⁸ Ω·m. The results are shown in Table 1.

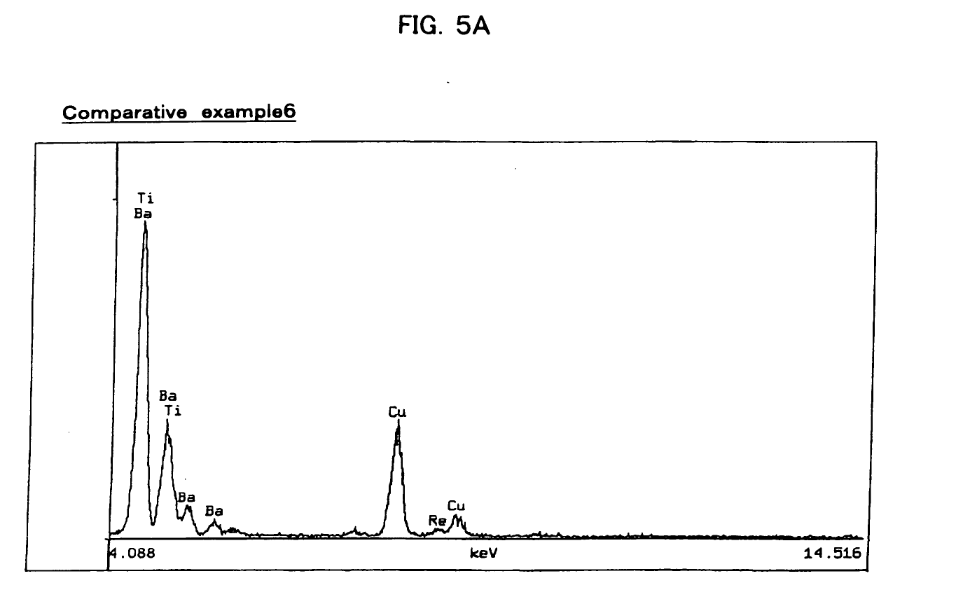

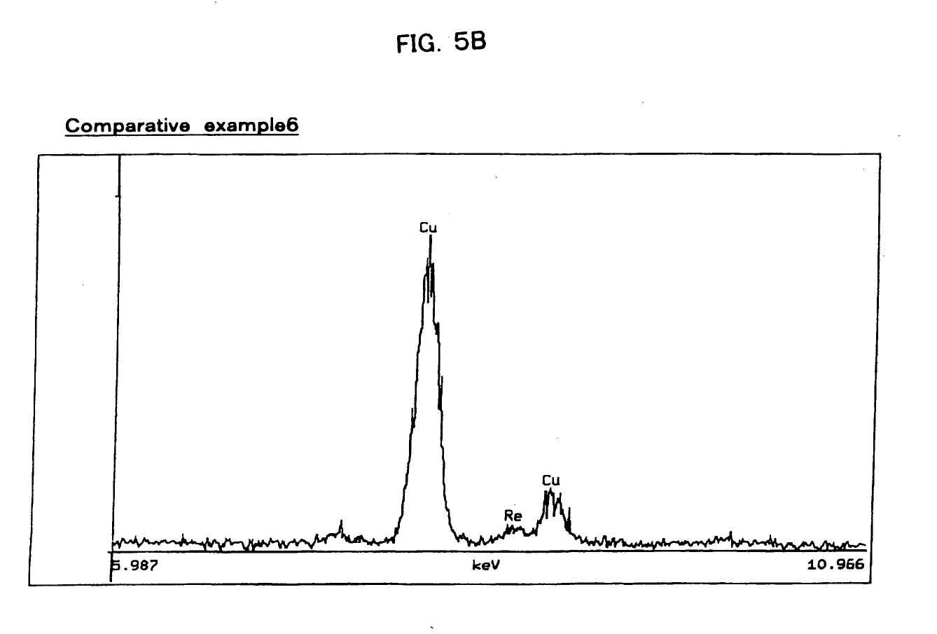

As shown in Table 1, example 1 to 13 and comparative example 1 to 4, the content ratio of Re included in internal electrode layer was 20 mol % with respect to the entire metal content (Ni—Re alloy) included in internal electrode layer. FIGS. 4A and 4B are TEM-EDS spectra obtained from one measurement point of dielectric layer in the example 1. Also, FIGS. 5A and 5B is TEM-EDS spectra obtained from one measurement point of dielectric layer of comparative example 4. In FIG. 4A, 4B, 5A, 5B, the lateral axis is an energy comprising the characteristic X-rays (KeV) excited by atoms included in dielectric layer. The vertical axis is the detected intensity (value corresponding to the content ratio (mol %) of atoms in the dielectric layer) of characteristic X-rays excited by atoms included in dielectric layer. Note that, the Cu peak of the spectra comes from supporting body used for the TEM observation, and the dielectric layer of example 1 and comparative example 4 does not include Cu.

As shown in FIG. 4A and FIG. 5A, the peak caused by Ba and Ti from BaTiO₃ of the main content of the dielectric layer was confirmed. As shown in FIGS. 4A and 4B, the peak was not observed in the energy band corresponding to the characteristic X-ray of Re in the example 1. That is, in this measuring point, Re was not detected (Re content ratio was equal or less than 0.5 mol % which is the detecting limit of the device). Also, other measuring point in the dielectric layer of the example 1 gave the same spectra as the FIGS. 4A and 4B. As shown in FIGS. 5A and 5B, in the comparative example 4, the peak was observed in the energy band corresponding to characteristics X-ray of Re. From the intensity of the peak, 3.4 mol % of Re was detected in this measuring point. Also, in the other measuring points in the dielectric ceramic layer of comparative example 1, as FIGS. 5A and 5B, the spectra indicating the Re content was obtained.

As shown in Table 1, in the example 1 to 13, the fired body was annealed under the condition of oxygen partial pressure 10⁻³ to 1 Pa, and holding temperature equal or higher than 700° C. and less than 1100° C. to form capacitor element body. As a result, in the example 1 to 13, Re was below the detection lower limit concentration (the detection limit of TEM analysis (lower limit) is 0.5 mol %), and substantially Re was not detected in the dielectric ceramic layer.

On the other hand, in the comparative example 1 to 4, the atmosphere for annealing the fired body was out of the range of oxygen partial pressure of 10⁻³ to 1 Pa, or out of the range of equal or higher than 700° C. and less than 1100° C. As a result, in the comparative example 1 to 4, Re was detected in dielectric layer. That is, with respect to the dielectric layer main component Ba, equal or more than 0.5 mol % of Re content was confirmed.

In the example 1 to 13 wherein Re is substantially not included in the dielectric layer, IR was confirmed to be larger (equal or larger than 7.0×10⁸Ω) compared to the comparative example 1 to 4 wherein the Re content ratio included in the dielectric layer exceeded 0.5 mol %. On the other hand, in any given comparative example, IR was small (less than 7.0×10⁸Ω).

Especially, in the example 4 to 13 wherein the fired body was annealed under the atmosphere of oxygen partial pressure being 10⁻³ to 1 Pa and holding temperature being equal or higher than 900° C. and less than 1100° C., IR was confirmed to be larger (equal or larger than 8.0×10⁸) compared to the other examples.

Also, in the comparative example 4, it was confirmed that the capacitance is smaller and tan δ were bigger compared to examples 1 to 13.

In the example 1 to 13, when comparing the examples having the same holding temperature (example 1 and 2, example 4 and 5, example 6 and 7, example 8 and 9, example 11 to 13), it was confirmed that IR was larger in the examples with lower oxygen partial pressure. It is speculated to be caused by suppression of Re oxidation and diffusion into the dielectric layer by lowering the oxygen partial pressure.

### Example 14 to 26 and Comparative Example 5 to 8

In the example 14 to 26 and comparative example 5 to 8, the Re content ratio of alloy powder included in the conductive material was 5.0 mol % or so with respect to entire alloy powder. Also, in example 14 to 26 and comparative example 5 to 8, the fired body was annealed under the atmosphere with holding temperature and oxygen partial pressure shown in Table 2. Except for those, the multilayer ceramic capacitor was made under the same conditions as example 1. Also, each capacitor was subject to the evaluation same as example 1. Results are shown in Table 2.

TABLE 2
Re content ratio included in internal electrode layer: 5.0 mol %

| | Annealing atmosphere | | | | | | |
|---|---|---|---|---|---|---|---|
| | | Oxygen | Re content ratio | | | Resistance | |
| | Holding | partial | included in dielectric | | | ratio of | |
| | temp. | pressure | layer | IR | Capacitance | electrode film | |
| | (°C) | (Pa) | (mol %) | (Ω) | (μF) | (×10⁻⁸ Ωm) | tan δ |
| Example 14 | 700 | 0.0020 | below the detection limit | 1.1E+09 | 1.7 | 12 | 0.17 |
| Example 15 | 700 | 0.020 | below the detection limit | 7.4E+08 | 1.6 | 12 | 0.13 |
| Example 16 | 800 | 0.013 | below the detection limit | 7.6E+08 | 1.7 | 12 | 0.1 |
| Example 17 | 900 | 0.0015 | below the detection limit | 1.3E+09 | 1.7 | 12 | 0.05 |
| Example 18 | 900 | 0.062 | below the detection limit | 9.0E+08 | 1.7 | 12 | 0.04 |
| Example 19 | 1000 | 0.076 | below the detection limit | 1.5E+09 | 1.6 | 12 | 0.01 |
| Example 20 | 1000 | 0.003 | below the detection limit | 2.1E+09 | 1.7 | 12 | 0.01 |
| Example 21 | 1030 | 0.11 | below the detection limit | 1.6E+09 | 1.6 | 12 | 0.01 |
| Example 22 | 1030 | 0.003 | below the detection limit | 2.1E+09 | 1.7 | 12 | 0.01 |
| Example 23 | 1050 | 0.1 | below the detection limit | 9.0E+08 | 1.6 | 12 | 0.02 |
| Example 24 | 1080 | 0.19 | below the detection limit | 8.5E+08 | 1.5 | 12 | 0.03 |
| Example 25 | 1080 | 0.003 | below the detection limit | 1.6E+09 | 1.4 | 12 | 0.02 |
| Example 26 | 1080 | 0.57 | below the detection limit | 8.5E+08 | 1.5 | 12 | 0.05 |
| Comparative example 5 | 1090 | 0.00061 | 0.6 | 4.0E+08 | 1.6 | 12 | 0.03 |
| Comparative example 6 | 1080 | 1.3 | 1.0 | 5.2E+06 | 1.4 | 12 | 0.08 |
| Comparative example 7 | 1100 | 0.23 | 0.8 | 1.8E+08 | 1.5 | 12 | 0.13 |
| Comparative example 8 | 1200 | 0.62 | 1.2 | 950 | 0.9 | 12 | 0.32 |

### Example 27 to 39 and Comparative Example 9 to 12

In the example 27 to 39 and comparative example 9 to 12, the Re content ratio in the alloy powder was 1.0 mol % or so with respect to entire alloy powder. Also, in example 27 to 39 and comparative example 9 to 12, the fired body was annealed under the atmosphere having holding temperature and oxygen partial pressure indicated in Table 3. Except for those, the multilayer ceramic capacitor was made under same conditions as example 1. Also, each capacitor was subject to the evaluations same as example 1. Results are shown in Table 3.

TABLE 3
Re content ratio included in internal electrode layer: 1.0 mol %

| | Annealing | | | | | | |
|---|---|---|---|---|---|---|---|
| | atmosphere | | | | | | |
| | | Oxygen | | | | Resistance | |
| | Holding | partial | Re content ratio | | | ratio of | |
| | temp. | pressure | included in the | | Capacitance | electrode film | |
| | (° C.) | (Pa) | dielectric layer (mol %) | IR (Ω) | (μF) | (×10⁻⁸ Ωm) | tan δ |
| Example 27 | 700 | 0.0020 | below the detection limit | 1.2E+09 | 1.6 | 8 | 0.17 |
| Example 28 | 700 | 0.020 | below the detection limit | 7.6E+08 | 1.6 | 8 | 0.14 |
| Example 29 | 800 | 0.013 | below the detection limit | 7.8E+08 | 1.7 | 8 | 0.09 |
| Example 30 | 900 | 0.0015 | below the detection limit | 1.4E+09 | 1.7 | 8 | 0.04 |
| Example 31 | 900 | 0.062 | below the detection limit | 9.0E+08 | 1.7 | 8 | 0.03 |
| Example 32 | 1000 | 0.076 | below the detection limit | 1.5E+09 | 1.6 | 8 | 0.01 |
| Example 33 | 1000 | 0.003 | below the detection limit | 2.2E+09 | 1.6 | 8 | 0.01 |
| Example 34 | 1030 | 0.11 | below the detection limit | 1.7E+09 | 1.6 | 8 | 0.01 |
| Example 35 | 1030 | 0.003 | below the detection limit | 2.2E+09 | 1.6 | 8 | 0.01 |
| Example 36 | 1050 | 0.1 | below the detection limit | 9.5E+08 | 1.5 | 8 | 0.02 |
| Example 37 | 1080 | 0.19 | below the detection limit | 9.0E+08 | 1.4 | 8 | 0.02 |
| Example 38 | 1080 | 0.003 | below the detection limit | 1.7E+09 | 1.4 | 29 | 0.02 |
| Example 39 | 1080 | 0.57 | below the detection limit | 9.0E+08 | 1.5 | 8 | 0.05 |
| Comparative example 9 | 1090 | 0.00061 | 0.5 | 4.5E+08 | 1.5 | 8 | 0.02 |
| Comparative example 10 | 1080 | 1.3 | 1 | 6.0E+06 | 1.4 | 8 | 0.05 |
| Comparative example 11 | 1100 | 0.23 | 0.8 | 2.3E+08 | 1.5 | 8 | 0.11 |
| Comparative example 12 | 1200 | 0.62 | 1.1 | 1230 | 0.9 | 8 | 0.3 |

Evaluation 2

As shown in Table 2, in example 14 to 26 and comparative example 5 to 8, the Re content ratio included in the internal electrode layer was 5.0 mol % with respect to entire metal composition (Ni—Re alloy) included in the internal electrode layer.

As shown in Table 3, example 27 to 39 and comparative example 9 to 12, the Re content ratio included in the internal electrode layer was 1.0 mol % with respect to entire metal composition (Ni—Re alloy) included in the internal electrode layer.

Despite of the fact that Re content ratio included in the internal electrode layer were different, the same results as Table 1 was confirmed in both Table 2 and Table 3.

That is, in example 14 to 39 wherein the fired body was annealed under the atmosphere having oxygen partial pressure of 10⁻³ to 1 Pa and holding temperature equal or higher than 700° C. and less than 1100° C., Re was substantially not included in the dielectric layer.

Also, in example 14 to 39 wherein Re is substantially not included in the dielectric layer, IR was confirmed to be large (equal or larger than 7.0×10⁸) compared to the comparative example 5 to 12 wherein the Re content ratio included in the dielectric layer exceeded 0.5 mol %.

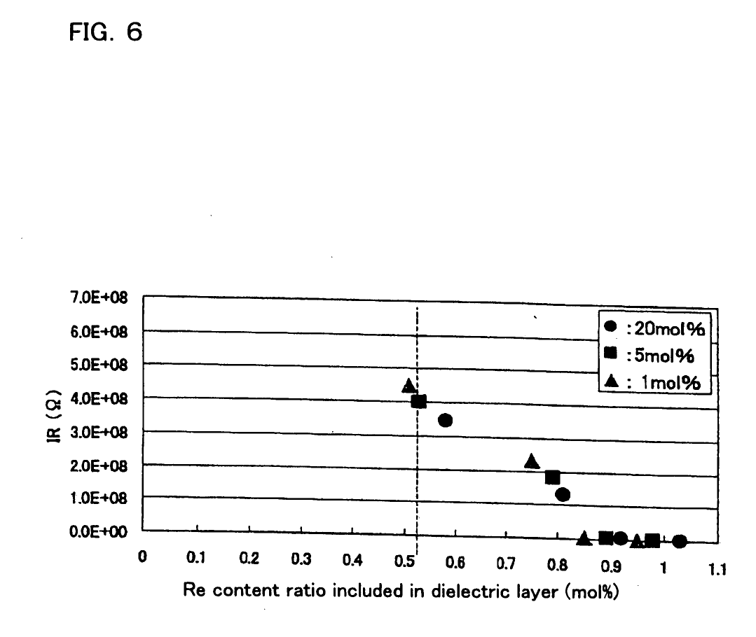

The results of comparative example 1 to 12 are shown in FIG. 6. In the graph shown in FIG. 6, the lateral axis indicates the Re content ratio included in the dielectric layer for each comparative example (capacitor), and the vertical axis indicates corresponding IR thereof. Also, the triangle mark, square mark, and circle mark in the graph indicates the Re content ratio included in the dielectric layer being 1.0 mol %, 5.0 mol % and 20 mol % respectively. Also, all the examples shown in Table 1 to 3 is not indicated in FIG. 6, since the Re content ratio was below the detection limit, plus IR was equal or larger than 7.0×10⁸Ω.

As shown in FIG. 6, regardless of the Re content ratio included in the internal electrode layer, when the content ratio of Re included in dielectric layer exceeds 0.5 mol %, IR was confirmed to decline dramatically. Also, it was confirmed that the larger the Re content ratio included in the dielectric layer is, the more the IR declines.

### Example 40 to 42

Except for setting; the Re content ratio included in the internal electrode layer, holding temperature and oxygen partial pressure of annealing atmosphere as the value shown in Table 4, the multi layer ceramic capacitor of example 40 to 42 was made by the same method as example 1. Also, these samples were subject to the evaluations of electrode coverage ratio and breakdown voltage addition to the same evaluations performed on example 1. The results are shown in Table 4.

Measurement of Electrode Coverage Ratio

The electrode coverage ratio was measured by cutting the multilayer ceramic capacitor sample so that the surface of electrode is exposed, and electrode surface thereof was subject to the SEM observation, and image processing. The electrode coverage ratio was preferably equal or more than 80%, and more preferably equal or more than 90%.

Measurement of Breakdown Voltage

The voltage at temperature rising speed 1 V/s and detected current 2 mA was set to breakdown voltage. The breakdown voltage was preferably equal or more than 90 V and further preferably equal or more than 100 V.

TABLE 4

| | Metals | Annealing atmosphere | | | | | Resistance | | | |
|---|---|---|---|---|---|---|---|---|---|---|
| | included | Hold- | Oxygen | | | | ratio of | | Cover- | Break- |
| | in the | ing | partial | | | Capac- | electrode | | age | down |
| | internal | temp. | pressure | Metal content ratio included | IR | itance | film (×10 − 8 | | ratio | voltage |
| | electrode layer | (°C) | (Pa) | in the dielectric layer (mol%) | (Ω) | (μF) | Ωm) | tan δ | (%) | (V) |
| Example 40 | Re: 5.0 mol % | 800 | 0.1 | Re: below the detection limit | 8.0E+08 | 1.7 | 12 | 0.1 | 90 | 105 |
| Example 41 | Re: 5.0 mol % | 900 | 0.1 | Re: below the detection limit | 9.5E+08 | 1.7 | 12 | 0.04 | 90 | 123 |
| Example 42 | Re: 5.0 mol % | 1030 | 0.1 | Re: below the detection limit | 1.6E+09 | 1.6 | 12 | 0.02 | 90 | 135 |
| Example 43 | Ru: 5.0 mol % | 800 | 0.1 | Ru: below the detection limit | 7.0E+08 | 1.2 | 7 | 0.35 | 70 | 53 |
| Example 44 | Ru: 5.0 mol % | 900 | 0.1 | Ru: below the detection limit | 1.0E+09 | 1.2 | 7 | 0.09 | 70 | 60 |
| Example 45 | Ru: 5.0 mol % | 1030 | 0.1 | Ru: below the detection limit | 1.5E+09 | 1.2 | 7 | 0.02 | 70 | 72 |
| Example 46 | Os: 5.0 mol % | 1030 | 0.1 | Os: below the detection limit | 1.4E+09 | 1.2 | 13 | 0.02 | 72 | 80 |
| Example 47 | Ir: 5.0 mol % | 1030 | 0.1 | Ir: below the detection limit | 1.5E+09 | 1.4 | 12 | 0.02 | 85 | 98 |

### Example 43 to 45

Except for using Ru instead of Re included in the internal electrode layer and the holding temperature and oxygen partial pressure of annealing atmosphere as shown in Table 4, multilayer ceramic capacitor of example 43 to 45 was made by the same method as example 1. Also, these samples were subject to the evaluations of electrode coverage ratio and breakdown voltage addition to the same evaluations performed to example 1. Results are shown in Table 4.

### Example 46

Except for using Os instead of Re included in the internal electrode layer and the holding temperature and oxygen partial pressure of annealing atmosphere as shown in Table 4, multilayer ceramic capacitor of example 46 was made by the same method as example 1. Also, the sample of example 46 was subject to the evaluations of electrode coverage ratio and breakdown voltage addition to the same evaluations performed to example 1. Results are shown in Table 4.

### Example 47

Except for using Ir instead of Re included in the internal electrode layer and the holding temperature and oxygen partial pressure of annealing atmosphere as shown in Table 4, multilayer ceramic capacitor of example 47 was made by the same method as example 1. Also, the sample of example 47 was subject to the evaluations of electrode coverage ratio and breakdown voltage addition to the same evaluations performed to example 1. Results are shown in Table 4.

Evaluation 3

From the results of example 43 to 47, similar facts as example 1 to 39, and 40 to 42 were confirmed. That is, by annealing the fired body under the atmosphere of oxygen partial pressure being 10⁻³ to 1 Pa and holding temperature being higher than 600° C. and less than 1100° C., it was confirmed that Ru, Os, and Ir were substantially not included in the dielectric layer. As a result, it was confirmed that the deterioration of the capacitor IR can be prevented.

Evaluation 4

In the example 40 to 42 and 47 wherein the Re and Ir are included in the internal electrode layer, though the IR is about the same level, the electrode coverage ratio, breakdown voltage and capacitance was confirmed to be larger compared to example 43 to 46 wherein either one of Ru or Os is included in internal electrode layer. That is, compared to Ru and Os, Re and Ir has bigger effect on preventing the spheroidization of electrode. Thus the electrode coverage ratio becomes bigger and the capacitance becomes higher as well. Also, as for the breakdown voltage, because the electrode is suppressed from becoming spherical, the unevenness of the thickness of dielectric layer is also suppressed as well, possibly resulting in high breakdown voltage.

Also, example 40 to 42 wherein Re is included was confirmed to have larger electrode coverage ratio, breakdown voltage, and capacitance compared to example 47 wherein Ir is included.

1. An electronic device comprising an element body with an internal electrode layer and a ceramic layer wherein;
said internal electrode layer includes at least one element from Re, Ru, Os, and Ir; and
said ceramic layer substantially doesn't includes Re, Ru, Ou, and Ir.

2. The electronic device as set forth in claim 1 wherein an content ratio of Ni included in said internal electrode is equal or more than 80 mol % and less than 100 mol % with respect to an entire metal composition included in said internal electrode layer; and
a total content ratio of Re, Ru, Os and Ir included in said internal electrode layer is more than 0 mol % and equal or less than 20 mol % with respect to the entire metal composition included in said electronic device.

3. The electronic device as set forth in claim 1 wherein said internal electrode forms alloy of Ni with at least one element from Re, Ru, Os, and Ir.

4. The method of production of the electronic device as set forth in claim 1 comprising steps of;
forming a green chip comprising an internal electrode layer film,
firing said green chip to form a fired body, and
forming said element body by annealing said fired body under an atmosphere with an oxygen partial pressure being more than 6.1×10⁻⁴ Pa and less than 1.3 Pa with a temperature being higher than 600° C. and lower than 1100° C.

5. The method of production of the electronic device as set forth in claim 4 wherein said element body is formed by annealing said fired body under an atmosphere with oxygen partial pressure being more than 6.1×10⁻⁴ Pa and equal or less than 1.3 Pa with the temperature being equal or higher than 900° C. and lower than 1100° C.

6. The method of production of the electronic device as set forth in claim 4 wherein said green chip is fired to form said fired body under the atmosphere of the oxygen partial pressure being 10⁻¹⁰ to 10⁻² Pa and the temperature being 1000° C. to 1300° C.

7. The method of production of the electronic device as set forth in claim 4 wherein said internal electrode layer film is formed by thin film method.

8. The method of production of the electronic device as set forth in claim 7 wherein said internal electrode layer film comprises crystal size of 10 to 100 nm.

9. The method of production of the electronic device as set forth in claim 7 wherein said internal electrode layer film is formed by spattering or evaporation.

10. The production of method of the electronic device as forth in claim 4 wherein said internal electrode layer film is formed by printing method using a conductive paste comprising an alloy powder with average particle size of 0.01 to 1 μm.

11. The production of method of the electronic device as set forth in claim 10 wherein said alloy powder comprises crystal size of 10 to 100 nm.

12. The method of production of electronic device as set forth in claim 10 wherein an alloy film is formed by thin film method and said alloy film is crushed to form said alloy powder.
